(19) United States
(12) Patent Application Publication
(10) Pub. No.: US 2010/0239122 A1
(43) Pub. Date: Sep. 23, 2010

(54) METHOD FOR CREATING AND/OR UPDATING TEXTURES OF BACKGROUND OBJECT MODELS, VIDEO MONITORING SYSTEM FOR CARRYING OUT THE METHOD, AND COMPUTER PROGRAM

(76) Inventors: Hans-Juergen Busch, Schwabach (DE); Dieter Joecker, Burgthann (DE); Stephan Heigl, Nuernberg (DE)

Correspondence Address: MICHAEL J. STRIKER, 103 EAST NECK ROAD, HUNTINGTON, NY, 11743, US

(21) Appl. No.: 12/682,069

(22) PCT Filed: Sep. 11, 2008
(86) PCT No.: PCT/EP08/62093

§ 371 Date: May 25, 2010

(30) Foreign Application Priority Data
Oct. 11, 2007 (DE) 102007048857.4

(51) Int. Cl. G06K 9/00; H04N 7/18

(52) U.S. Cl. 382/103; 348/143; 348/E07.085

(57) ABSTRACT

Video monitoring systems are used for camera-supported monitoring of relevant areas, and usually comprise a plurality of monitoring cameras placed in the relevant areas for recording monitoring scenes. The monitoring scenes may be, for example, parking lots, intersections, streets, plazas, but also regions within buildings, plants, hospitals, or the like. In order to simplify the analysis of the monitoring scenes by monitoring personnel, the invention proposes displaying at least the background of the monitoring scene on a monitor as a virtual reality in the form of a three-dimensional scene model using background object models. The invention proposes a method for creating and/or updating textures of background object models in the three-dimensional scene model, wherein a background image of the monitoring scene is formed from one or more camera images 1 of the monitoring scene, wherein the background image is projected onto the scene model, and wherein textures of the background object models are created and/or updated based on the projected background image.

### BACKGROUND INFORMATION

The present invention relates to a method for creating and/or updating textures of background object models in a three-dimensional scene model of a surveillance scene that contains background objects, to a control device and a video surveillance system for carrying out the method, and to a computer program.

Video surveillance systems are used for the camera-supported monitoring of relevant regions, and typically include a plurality of surveillance cameras that are installed in the relevant regions in order to record surveillance scenes. The surveillance scenes may be designed, e.g., as parking lots, intersections, streets, public places, or as regions in buildings, factories, hospitals, or the like. The image data streams that are recorded by the surveillance cameras are combined in a surveillance center, where they are evaluated in an automated manner or by surveillance personnel.

However, the work carried out by the surveillance personnel in order to perform the manual evaluation is made difficult by the fact that the image quality of the surveillance scenes that are displayed are often classified as inadequate due to changes in lighting, influences of weather, or contamination of the surveillance cameras.

To simplify the work to be performed by the surveillance personnel, and to simultaneously improve the quality of surveillance, German laid-open application DE 10001252 A 1 provides a surveillance system that makes it possible to more efficiently work with a surveillance system via the use of an object-oriented display. To this end, signals from the cameras that are used for the particular views that are selected are broken down into objects and transmitted to a display, and artificial objects are added and other objects are deleted.

### DISCLOSURE OF THE INVENTION

A method for creating and/or updating textures of background object models in a three-dimensional scene model having the features of claim 1, a control device for carrying out the method having the features of claim 10, a video surveillance system according to claim 11, and a computer program having the features of claim 12 are provided within the scope of the present invention. Preferred or advantageous embodiments of the present invention result from the dependent claims, the description that follows, and the figures.

The present invention makes it possible to depict surveillance scenes, at least in sections, in a virtual reality or a semi-virtual reality in the form of a three-dimensional scene model; it is possible to attain a particularly realistic depiction of the surveillance scene by generating and/or updating textures of background object models in the three-dimensional scene model. Given that the surveillance scene is depicted in a virtual yet highly realistic manner, it is very easy for the surveillance personnel to alternate, without error, between an actual observation of the surveillance scene and an observation of the virtual, three-dimensional scene model.

Stated more generally, the method makes it possible to depict a surveillance scene that is real, in particular, and that contains background objects onto a three-dimensional scene model that contains background object models having realistic textures. As mentioned initially, the surveillance scene may be streets, intersections, public places, or regions in buildings, factory areas, prisons, hospitals, etc.

The background objects are preferably defined as static and/or quasi-static objects that do not change or that change slowly, and that are depicted on the background object models. Typical static objects are buildings, trees, boards, etc. The quasi-static objects are, e.g., shadows, parked cars, or the like. The static objects have a dwell time in the surveillance scene of preferably more than several months, while quasi-static objects preferably have a dwell time that exceeds one or more days.

The three-dimensional scene model includes the background object models, each of which is depicted as a three-dimensional model. For example, the three-dimensional scene model is depicted as “walkable”, thereby making it possible for a user to move within the three-dimensional scene model between the background object models, and/or to change the view by adjusting the direction of angle of viewing. In particular, depth information and/or an overlap hierarchy (Z hierarchy) of the background object models is stored in the three-dimensional scene model.

The background object models and, optionally, the rest of the background have textures, the textures being preferably designed as color, shading, patterns, and/or features of the surface of the background objects.

In one method step, a background image of the surveillance scene is formed on the basis of one or more camera images of the surveillance scene, and it is preferably provided that foreground objects or other interfering objects are hidden or suppressed. The background image may be designed to be identical to the camera images in terms of its cardinality, i.e., in terms of the columns and rows of pixels. As an alternative, the background image is a section of one or more camera images. It is also possible for the background image to have any type of outline, and so, e.g., a background image may represent exactly one background object.

In a further method step, the background image is projected onto the scene model. In this case, the background image is designed such that one image point of a background object matches a corresponding model point of the background object model. The projection may also take place pixel-by-pixel in the form of an imaging specification, in which preferably only those image points are depicted for which a corresponding model point is available.

Once the background image has been projected onto the scene model or the background object models, the textures of the background object models are created and/or updated on the basis of the projected background image. To this end, e.g., image regions that are assigned, after the projection, to the particular background object model in the correct position are removed from the background image and used as texture.

Optionally, the textures of the background object models are each stored with orientation information, thereby making it possible to distribute the textures onto the background object models with correct position and projection when the scene model is depicted on a monitor or the like.

In summary, the method makes it possible to equip a three-dimensional scene model with realistic textures, it being possible to update the textures at regular or irregular intervals.

In a preferred embodiment of the present invention, the background image is formed via long-term observation, i.e., an observation carried out over several days, and via time-based filtering, that is, e.g., by averaging, forming moving averages, or by eliminating foreground objects. It is also possible to determine the median of a plurality of camera images, or to cut out known objects. Basically, any known method may be used to create the background image.

In a preferred implementation of the method, the background image is projected onto the scene model, using the parameters of a camera model from the surveillance camera from the perspective of which the background image was created. By using the parameters of the camera model it is possible to project a point in the coordinate system of the surveillance scene into the coordinate system of the camera image, and vice versa. As an alternative to the camera model, a look-up table may also be used, which provides a corresponding point in the coordinate system of the surveillance scene for every image point in the camera image of the surveillance camera.

By using an assignment specification between the surveillance scene and the camera image, it is possible to project the background image, that was created from the camera image, in the correct position or in a perspective-corrected manner onto the scene model, thereby minimizing misallocations.

In an industrial application of the method, the background image is also, optionally, corrected for distortions that may have been accidentally created due to imaging errors in the surveillance camera system, e.g., as optical imaging errors, or for intended distortions that are added, e.g., via the use of 360° cameras or fisheye cameras.

In a further preferred embodiment of the present invention, the background image and/or image regions of the background image and/or image points of the background image, in particular every image point of the background image, is checked to determine if it is hidden by other static or quasi-static objects. If it is determined in this check that the investigated region is hidden by an interfering object, this image point is discarded. Otherwise, the investigated region is used to create and/or update the textures.

In a further possible supplement to the present invention, a depth buffer is used to determine if background object models hide each other; image points that should be assigned to a background object model that is hidden in the region of the corresponding model point are discarded. The depth buffer is based, e.g., on a z hierarchy that is known from rendering.

In a development of the present invention, the textures are formed on the basis of a plurality of camera images that originate from the same surveillance camera and from the same viewing angle, or from different viewing cameras that have different viewing angles of the surveillance scene. In this case, the camera images are projected from various viewing angles, in the manner described, onto the scene model in the correct position. After the projection, image points of various background images that belong to a common texture point or a common texture of a background object model are blended. The blending may be carried out, e.g., via averaging. In a particularly preferred development of the present invention, color matching of the image points to be blended is carried out.

Optionally, in addition, texture information is drawn from other sources, such as aerial photographs, in particular to cover gaps in a surveillance region formed by the surveillance scenes.

In a particularly preferred embodiment of the method, the background object models that include the textures are depicted in a display unit, such as a monitor or the like, of a video surveillance system, in particular as described below.

A further subject matter of the present invention relates to a video surveillance system that is connected and/or connectable to a plurality of surveillance cameras, and that includes a control device, characterized in that the control device is designed, in terms of circuit engineering and/or programming, to execute the above-described method and/or as defined in the preceding claims.

Particularly preferably, the video surveillance system is designed such that the above-described method runs at periodic intervals, preferably in the background, thereby keeping the textures current. A particular advantage of the video surveillance system is that only the static and/or quasi-static scene background is taken into account when creating or updating the textures. As a result, dynamic objects from the video images do not appear in the texture of the static geometry of the 3D model, which could result in a faulty depiction of the dynamic objects as texture on the background object models, e.g., flat on the street or on walls. In contrast, the dynamic objects may be blended into the scene model separately, either as a real image or as a virtual depiction, thereby resulting in a plausible or realistic visualization.

A final subject matter of the present invention relates to a computer program having program code means to carry out all steps of the above-described method when the program is run on a computer and/or a video surveillance system.

### BRIEF DESCRIPTION OF THE DRAWINGS

Further features, advantages, and effects of the present invention result from the description that follows of a preferred embodiment of the present invention, and from the attached figures.

FIG. 1 shows a flow chart which illustrates a first embodiment of the method according to the present invention;

FIG. 2 shows a block diagram of a video surveillance system for carrying out the method according to FIG. 1.

### EMBODIMENT(S) OF THE INVENTION

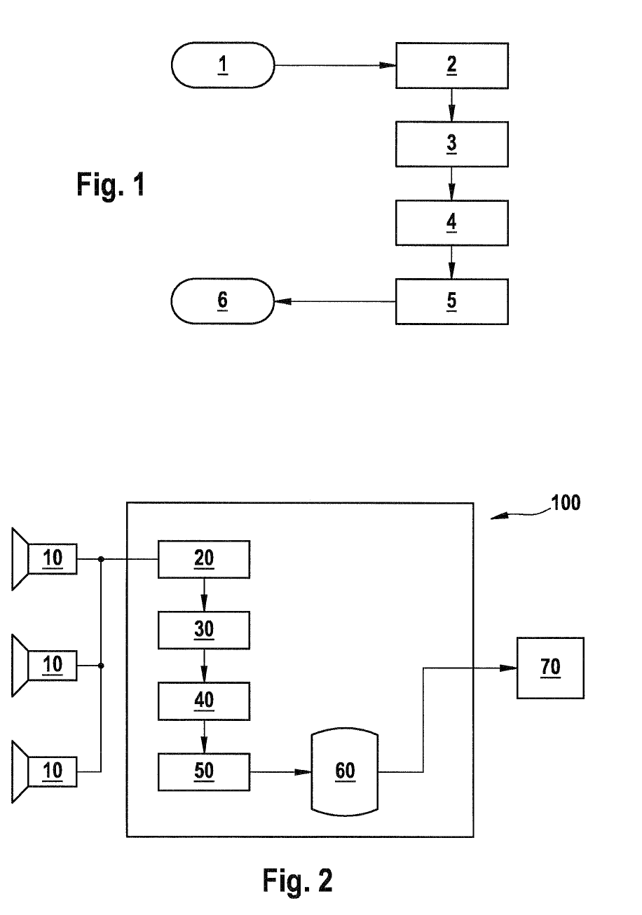

FIG. 1 shows, in a schematic flow chart, the sequence of steps in a method for creating and/or updating textures of background object models in a three-dimensional scene model, as an embodiment of the present invention.

One or more video images 1, which originate from surveillance cameras 10 (FIG. 2), are used as current input information. Video images 1 are transmitted, in a first method step 2, to a background image that includes background pixels. The transmission is carried out using methods that are known from image processing, e.g., determining the mean or median of a plurality of video images 1, cutting out known objects, long-term observation, or the like. Via this method step, a background image is created that includes, as active image points, only background pixels from video image(s) 1, and optionally deactivated image points that are set at the positions of video image 1 at which an interfering object or foreground object is depicted.

In a second method step 3, the background image, which is created in this manner, is projected onto a scene model. The scene model is designed as a three-dimensional scene model and includes a large number of background object models, e.g., that are representative of buildings, furniture, streets, or other static objects. Within the scope of method step 3, the image points of the background image in the image coordinate system are projected onto the particular corresponding point of the three-dimensional scene model with the aid of parameters of the camera model of the surveillance cameras that delivered the video image on which the background image is based. Optionally, in addition, distortions, e.g., deformations or the like are corrected within the scope of the projection.

In a third method step 4, a check is carried out, image point by image point, using a depth buffer to determine if anything is hidden, as viewed by the camera. Checks are carried out to determine whether an image point of the background image, that was projected via method step 3 onto a background object model, is hidden by another background object model and/or a real, e.g., dynamic object in the current camera view. If it is determined in the test that the image point being investigated is hidden, it is discarded and no longer used. Otherwise, the image point, i.e., the projected video image point or the background image point is used to create and/or update the textures.

In a fourth method step 5, textures 6 are created and output on the basis of the background image points that were transmitted. As a supplemental measure, it may be provided that a plurality of image points of various background images, which overlap at least in sections after the projection and therefore relate to the same regions of the same background object models, are blended to form one common background image point. Color matching may also be carried out, for example. As a further supplemental measure, in particular, any gaps that remain in the scene model may be filled by static textures which originate, e.g., from aerial photographs.

FIG. 2 shows a video surveillance system 100 that is designed to carry out the method described with reference to FIG. 1. The video surveillance system is connected via signals to a plurality of surveillance cameras 10 in a wireless or wired manner, and is designed, e.g., as a computer system. Surveillance cameras 10 are directed to relevant regions that show surveillance scenes in the form of public places, intersections, or the like.

The image data streams from surveillance cameras 10 are transmitted to a background module 20 that is designed to carry out first method step 2 in FIG. 1. The background image(s) that are created are forwarded to a projection module 30 that is designed to carry out second method step 3. To check for hidden objects, the projected background images are forwarded to a hidden-object module 40 that is designed to carry out third method step 4. In a texture module 50, textures 6 are created or updated on the basis of the background images that were inspected, and are forwarded to a texture storage device 60.

On the basis of the stored data and the three-dimensional scene model, a virtual depiction of the surveillance scene, including background object models that have real textures, is displayed on a display unit 70, such as a monitor. Real objects, such as dynamic objects in the surveillance scene, may be inserted into this virtual display in the correct position and in a realistic manner.

What is claimed is:

1. A method for creating and/or updating textures (6) of background object models in a three-dimensional scene model of a surveillance scene that contains background objects,
in which a background image of the surveillance scene is formed (2) based on one or more camera images (1) of the surveillance scene,
in which the background image is projected onto the scene model (3)
and in which textures of the background object models are created and/or updated (5) on the basis of the projected background image.

2. The method as recited in claim 1,
wherein
the background image is formed via long-term observation, filtering, and/or by eliminating foreground objects.

3. The method as recited in claim 1,
wherein
a camera model is used to project the background image.

4. The method as recited in claim 1,
wherein
the background image is projected onto the scene model in the correct position and/or
in a perspective-corrected manner.

5. The method as recited in claim 3,
wherein
the background image is distortion-corrected.

6. The method as recited in claim 1,
wherein
a region of a background object model that corresponds to the background image and/or an image region of the background image and/or an image point of the background image is checked to determine if they are hidden by other background object models (4).

7. The method as recited in claim 1,
wherein
the textures (6) are formed on the basis of a plurality of camera images (1) that originate from various viewing angles of the surveillance scene.

8. The method as recited in claim 7,
wherein
image points of various background images that belong to a common texture point or a common texture of a background object model are blended.

9. The method as recited in claim 1,
wherein
the background object models with the textures are displayed in a display unit of a video surveillance system (100).

10. A control device (100),
wherein
the control device (100) is designed, in terms of circuit engineering and/or programming, to carry out the method as recited in claim 1.

11. A video surveillance system that is connected or connectable to one or a plurality of surveillance cameras (10),
wherein
the video surveillance system includes a control device (100) as recited in claim 10.

12. A computer program comprising program code means for carrying out all steps of the method as recited in claim 1 when the program is run on a computer and/or a control device, and/or on a video surveillance system.
